(19) United States
(12) Patent Application Publication
(10) Pub. No.: US 2010/0115095 A1
(43) Pub. Date: May 6, 2010

(54) AUTOMATICALLY MANAGING RESOURCES AMONG NODES

(76) Inventors: Xiaoyun Zhu, Cupertino, CA (US); Donald E. Young, Portland, OR (US); Brian J. Watson, Santa Clara, CA (US); Zhikui Wang, Fremont, CA (US); Jerome Rolia, Kanata (CA); Sharad Singhal, Belmont, CA (US); Bret A. McKee, Fort Collins, CO (US); Chris D. Hyser, Victor, NY (US); Robert D. Gardner, Fort Collins, CO (US); Thomas W. Christian, Fort Collins, CO (US); Ludmila Cherkasova, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/262,392

(22) Filed: Oct. 31, 2008

(51) Int. Cl. G06F 15/173

(52) U.S. Cl. 709/226

(57) ABSTRACT

A system for managing resources automatically among nodes includes a node controller configured to dynamically manage allocation of node resources to individual workloads, where each of the nodes is contained in one of a plurality of pods. The system also includes a pod controller configured to manage live migration of workloads between nodes within one of the plurality of pods, where the plurality of pods are contained in a pod set. The system further includes a pod set controller configured to manage capacity planning for the pods contained in the pod set. The node controller, the pod controller and the pod set controller are interfaced with each other to enable the controllers to meet common service policies in an automated manner. The node controller, the pod controller and the pod set controller are also interfaced with a common user interface to receive service policy information.

### CROSS-REFERENCES

The present application has the same Assignee and shares some common subject matter with U.S. patent application Ser. No. 11/492,353 (Attorney Docket No. 200506591-1), filed on Jul. 25, 2006, now abandoned; U.S. patent application Ser. No. 11/492,307 (Attorney Docket No. 200507437-1), filed on Jul. 25, 2006; U.S. patent application Ser. No. 11/742,530 (Attorney Docket No. 200700357-1), filed on Apr. 30, 2007; U.S. patent application Ser. No. 11/492,376 (Attorney Docket No. 200601298-1), filed on Jul. 25, 2006; U.S. patent application Ser. No. 11/413,349 (Attorney Docket No. 200504202-1), filed on Apr. 28, 2006; U.S. patent application Ser. No. 11/588,691 (Attorney Docket No. 200504718-1), filed on Oct. 27, 2006; U.S. patent application Ser. No. 11/489,967 (Attorney Docket No. 200506225-1), filed on Jul. 20, 2006; U.S. patent application Ser. No. 11/492,347 (Attorney Docket No. 200504358-1), filed on Apr. 27, 2006; and U.S. patent application Ser. No. 11/493,349 (Attorney Docket No. 200504202-1), filed on Apr. 28, 2006. The disclosures of the above-identified U.S. Patent Applications are hereby incorporated by reference in their entireties.

### BACKGROUND

Data centers provide a centralized location where a distributed network of servers shares certain resources, such as compute, memory, and network resources. The sharing of such resources in data centers typically reduces wasteful and duplicative resource requirements and thus, data centers provide benefits over individual server operations. This has led to an explosive growth in the number of data centers as well as the complexity and density of the data centers. One result of this growth is that management of complex data centers has also become increasingly more difficult and expensive.

For instance, managing both the infrastructure and the applications in a large and complicated centralized networked resource environment, such as modern data centers, raises many challenging operational scalability issues. By way of example, it is desirable to share computing and memory resources among different customers and applications to reduce operating costs. However, customers typically prefer dedicated resources that offer isolation and security for their applications as well as flexibility to host different types of applications. Attempting to assign or allocate resources in a data center in an efficient manner which adequately addresses issues that are impacted by the assignment has thus proven to be very difficult and time consuming.

Typically, the resources are assigned or allocated manually by a data center operator, oftentimes in a random or a first-come-first-served manner. In addition, manual assignment of the resources often fails to address energy efficiency concerns as well as other customer service level objectives (SLOs). Moreover, the dynamic nature and high variability of the workloads in many applications, especially electronic business (e-business) applications, typically requires that the resources allocated to an application be easily adjustable to maintain the SLOs.

Although virtualization of resource allocation provides benefits by driving higher levels of resource utilization, it also contributes to the growth in complexity in managing the data centers. Thus, it would be beneficial to be able to substantially reduce the amount of time and labor required of data center operators in managing the growingly complex data centers, while more fully realizing the benefits of virtualization.

### BRIEF DESCRIPTION OF DRAWINGS

The embodiments of the invention will be described in detail in the following description with reference to the following figures.

FIG. 1 illustrates a block diagram of a resource management system, according to an embodiment;

FIG. 2 illustrates a flow diagram of a method of managing resources automatically among a plurality of nodes, according to an embodiment;

FIGS. 3A and 3B, collectively, show a flow diagram of a method of managing resources automatically among a plurality of nodes that is similar to, and includes more detailed steps than, the method depicted in FIG. 2, according to an embodiment; and

FIG. 4 illustrates a block diagram of a computing apparatus configured to implement or execute either or both of the methods depicted in FIGS. 2, 3A and 3B, according to an embodiment.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures have not been described in detail so as not to unnecessarily obscure the embodiments.

Disclosed herein is a resource management system and a method for managing resources automatically among a plurality of nodes. The resource management system includes multiple levels of controllers that operate at different scopes and time scales. The multiple levels of controllers may generally be considered as leveraging resource knobs that range from short-term allocation of system-level resources among individual workloads on a shared server, to live migration of virtual machines between different servers, and to the organization of server clusters with groups of workloads configured to maximize efficiencies in combining long-term demand patterns.

In addition, the controllers at the multiple levels are integrated with each other to facilitate automated capacity and workload management in allocating the resources. Specific interfaces are also defined between the individual controllers such that the controllers are coordinated with each other at runtime. The controllers may thus run simultaneously while potential conflicts between them are substantially eliminated. By way of example, the interfaces include the sharing of policy information, such that policies do not have to be duplicated among the controllers, as well as coordination among the multiple controllers.

Through implementation of the resource management system and method disclosed herein, the mapping of physical resources to virtual resources may be automated to substantially minimize the hardware and energy costs associated with performing applications, which meet one or more service level objectives (SLOs). In addition, by adjusting the resource knobs in a substantially continuous manner as conditions change in the data center, hardware and energy costs may substantially be minimized while meeting the SLOs. As such, the resource management system and method disclosed herein generally afford data center operators with the ability to focus on service policy settings, such as, response time and throughput targets, or the priority levels of individual applications, without having to worry about the details of where an application is hosted or how the application shares resources with other applications.

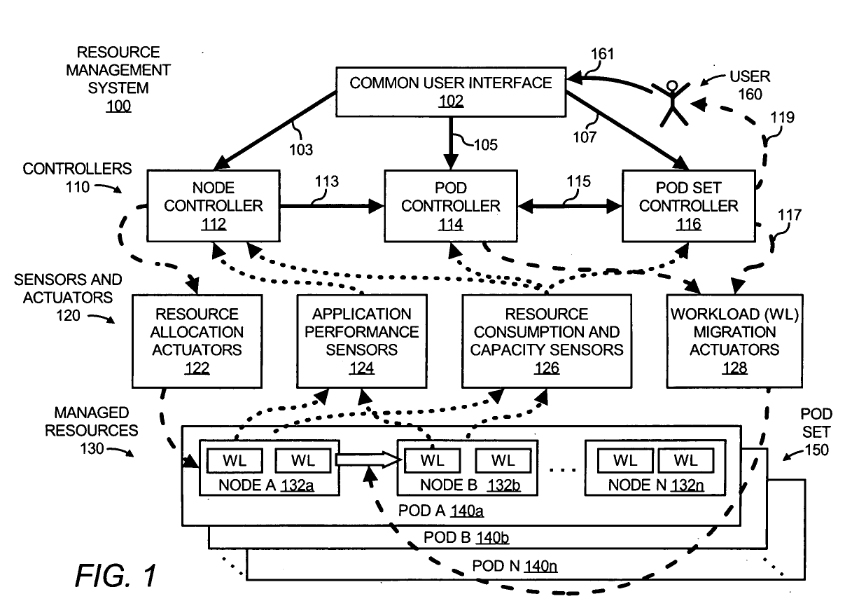

With reference first to FIG. 1, there is shown a block diagram of a resource management system 100, according to an example. It should be understood that the resource management system 100 may include additional elements and that some of the elements described herein may be removed and/or modified without departing from a scope of the resource management system 100.

The resource management system 100 is depicted in multiple levels. A first level includes a common user interface 102. A second level includes controllers 110. A third level includes sensors and actuators 120. And a fourth level includes managed resources 130.

The controllers level 110 is depicted as including a node controller 112, a pod controller 114, and a pod set controller 116. The sensors and actuators level 120 is depicted as including resource allocation actuators 122, application performance sensors 124, resource consumption and capacity sensors 126, and workload (WL) migration actuators 128. The managed resources level 130 is depicted as including a plurality of nodes 132a-132n arranged in a plurality of pods 140a-140n, which form a pod set 150.

Each of the nodes 132a-132n is depicted as including workloads (WL), which comprise abstractions that encapsulate a set of work to be done, such as virtual machines, process groups, etc. Generally speaking, the nodes 132a-132n, which comprise servers, are configured as virtual machines to implement or execute an application, which may be composed of multiple workloads (WL). As such, multiple virtual machines on nodes 132a-132n may be assigned to perform the WLs of a single application. The multiple virtual machines that compose a single application may be hosted on a single node or on multiple nodes 132a-132n.

The nodes 132a-132n are depicted as being grouped into pods 140a-140n. The pods 140a-140n may be defined based upon the virtual machine live migration as a set of nodes 132a-132n, such that a virtual machine is able to live migrate between any two nodes in the set. As such, for the nodes 132a-1 32n to be included in a particular pod 140a, the nodes 132a-132n require compatible configurations for the live migration, such as similar CPU types, mutual access to the same shared storage device, etc. In addition, the requirements for determining which pod 140a-140n that a particular node 132a belongs may be technology dependent on the particular type of live migration used among the nodes 132a-132n. In addition, or alternatively, the nodes 132a-132n may be assigned to the particular pods 140a-140n based upon other attributes of the nodes 132a-132n, such as, the physical or virtual locations of the nodes 132a-132n, the network switches to which the nodes 132a-132n are connected, etc.

The pod set 150 may be defined as including a plurality of non-overlapping pods 140a-140n. The pods 140a-140n are considered to be non-overlapping because each of the nodes 132a-132n is assigned to only one of the pods 140a-140n. The pods 140a-140n forming or contained in a pod set 150 may comprise all of the pods 140a-140n or a subset of all of the pods 140a-140n contained in one or more data centers. The assignment of the pods 140a-140n to one or more pod sets 150 may be based upon various factors, such as, physical configurations of the nodes 132a-132n contained in the pods 140a-140n, workload types assigned to the nodes 132a-132n contained in the pods 140a-140n, etc. By way of example, the pods 140a-140n of a particular pod set 150 may each include nodes 132a-132n in which workloads are able to be non-live migrated between the nodes 132a-132n contained in different pods 140a-140n. Again, the pods 140a-140n of a pod set 150 need not be located in the same data center, but may be located in multiple data centers, so long as the conditions described above are met.

Also shown in FIG. 1 are a plurality of solid arrows, dashed arrows and dotted arrows. The solid arrows generally represent communication of policy information or information pertinent to integration of the node controller 112, the pod controller 114, and the pod set controller 116. The dashed arrows generally represent communication of actuation or control signals between the controllers 112, 114, 116, the resource allocation actuators 122, the workload migration actuators 128, and the nodes 132a-132n. And, the dotted arrows generally represent metrics detected and communicated by the application performance sensors 124 and the resource consumption and capacity sensors 126.

The application performance sensors 124 are configured to measure application level performance metrics, such as response time, throughput for the workloads of an application, etc. The resource consumption and capacity sensors 126 are configured to measure, for instance, how much CPU and memory each virtual machine is using on average for a given period of time, as well as the CPU capacity and memory capacity that a given node 132a-132n has. In other words, the resource consumption and capacity sensors 126 are configured to determine the real resource allocations on the nodes 132a-132n for a given workload. As shown, the application performance sensors 124 communicate the measured application level performance metrics to the node controller 112. In addition, the resource consumption and capacity sensors 126 communicate the sensed data to all three of the controllers 112-116.

Although a single node controller 112, a single pod controller 114, and a single pod set controller 116 have been depicted in FIG. 1, it should be understood that the resource management system 100 may include any suitable numbers of each of these controllers 112,114,116 depending upon the granularity of control desired and the number of nodes and pods contained in the resource management system 100. By way of example, the resource management system 100 may include a node controller 112 for each node, a pod controller 114 for each pod, and a pod set controller 116 for each pod set contained in the resource management system 100. Thus, although particular reference is made to individual ones of the controllers 112, 114, 116, it should be understood that the descriptions provided with respect to the individual controllers 112, 114, 116 may applied to any suitable numbers of the controllers 112,114,116.

The node controller 112, the pod controller 114 and the pod set controller 116 also receive service policy information from the common user interface 102, which may be entered into the resource management system 100 by a user 160 through the common user interface 102, as indicated by the arrow 161. As shown, the service policy information may be entered once through the common user interface 102, which may comprise a graphical user interface which may be presented to the user 160 via a suitable display device, and communicated to each of the node controller 112, pod controller 114, and pod set controller 116, as indicated by the solid arrows 103-107. As such, a user 160 is not required to separately enter and communicate the service policy information to each of the node controller 112, pod controller 114, and pod set controller 116. In addition, the service policy information may be communicated to each of the node controller 112, the pod controller 114, and the pod set controller 116 in a synchronized manner. One result of this synchronized policy distribution is that the policies may automatically be unfolded onto the controllers 112, 114, 116 such that they are operated in a synergistic manner.

The service policy information may be broken up into different types of information, which are communicated to the node controller 112, the pod controller 114, and the pod set controller 116. For instance, the service policy information communicated to the node controller 112, referenced by the arrow 103, may comprise SLOs and workload priority information. As another example, the service policy information communicated to the pod controller 114, referenced by the arrow 105, may comprise workload placement policies as well as workload priority information. Moreover, the service information communicated to the pod set controller 116, referenced by the arrow 107, may comprise policies for the node controller 112, the pod controller 114, and the pod set controller 116.

By way of example with respect to the pod set controller 116, the service policy information may include an instruction indicating that a particular workload is to receive a certain quality of service (QoS) level. In this example, the pod set controller 116 may take the QoS level instruction into account when deciding how to globally optimize a pod 140a-140n. For instance, the pod set controller 116 may allow a workload to have a lower QoS (for example, where the workload does not receive all of the requested resources) and the pod set controller 116 may take that into account when making packing decisions about which workloads should go into each pod 140a-140n and onto which node 132a-132n.

Similarly, the node controller 112, equipped with the same instruction, may enable the node controller 112 to take a workload and divide the demands of the workload across two classes of service, for instance, an “own” class, which is a very high priority class of service and a “borrow” class, which is a lower priority class of service. In this example, a certain portion of the demand up to some limit would be owned and the rest will be borrowed and they may be satisfied if resources are available. In addition, the pod set controller 116 may determine the portion of the demand that must be owned and how much of the demand must be borrowed based upon historical data. An example of the use of different classes of service is described in greater detail in copending and commonly assigned U.S. patent application Ser. No. 11/492,376 (Attorney Docket No. 200601298-1), the disclosure of which is hereby incorporated by reference in its entirety.

As another example, the priority levels of different workloads may be used to guide resource allocation in both the node controller 112 and the pod controller 114 when there are resource constraint situations. In this example, the service policy information pertaining to the different priority levels may originate from the same user instructions and may be communicated to both the node controller 112 and the pod controller 114. As such, the service policy information need not be entered into the node controller 112 and the pod controller 114 individually.

As a further example, there may arise situations where multiple customers are serviced in a cloud computing data center, where the multiple customers may have policies where one of the customers requires that their virtual machines are not on the same node as another customer's virtual machines. In these situations, a single service policy instruction pertaining to this constraint may be entered through the common user interface 102 and communicated to both the pod set controller 116 and the pod controller 114 to prevent such allocation of workloads.

A node controller 112 may be associated with each node 132a-132n in a pod 140a-140n and manages the dynamic allocation of the node's resources to each individual workload running in a virtual machine. Each of the node controllers 112 is configured to translate the service policy information for a given application along with the values from the feedback information received from the application performance sensors 124 into an allocation that is required for each workload of the application, such that the requirements in the service policy may be met. In other words, for instance, each of the node controllers 112 operates to dynamically adjust each workload's resource allocations to satisfy SLOs for the applications. In addition, the node controllers 112 may operate under a relatively short time scale, for instance, over periods of seconds, to continuously adjust the resource allocations of the workloads to satisfy the SLOs for the applications. Various manners in which the node controllers 112 may operate are described in greater detail in U.S. patent application Ser. No. 11/492,353 (Attorney Docket No. 200506591-1), and in U.S. patent application Ser. No. 11/492,307 (Attorney Docket No. 200507437-1), the disclosures of which are hereby incorporated by reference in their entireties.

In addition, each of the node controllers 112 tunes the resource allocation actuators 122 to effectuate allocation of the node resources based upon the determined allocations. More particularly, the resource allocation actuators 122 control how much resources, such as CPU, memory, disk I/O, network bandwidth, etc., each workload gets on whichever node the workload happens to be on at a given time.

Each of the node controllers 112 is also configured to pass the information pertaining to resource demands of the workloads to the pod controller 114 as indicated by the solid arrow 113, to facilitate integration between the node controllers 112 and the pod controller 114. In various instances, the node controllers 112 may communicate different information to the pod controller 114 than the information communicated to the resource allocation actuators 122. For instance, the node controllers 112 may inform the pod controller 114 of the resources that the workloads really should have in order to meet the application's performance requirements. However, there may be constraints on a particular node 132a-132n that the node controller 112 is managing, where the node controller 112 is unable to allocate all of those resource requirements. In these instances, the node controller 112 arbitrates between the workloads, for example, using priorities, various mechanisms, such as, various policies, to give the workloads less resources than what they really should be allocated to meet the performance requirements. In addition, the node controller 112 informs the pod controller 114 of the resources that the workloads really require so that the pod controller 114 may attempt to move workloads among nodes 132a-132n in a particular pod 140a to substantially ensure that the workloads will have their requisite resource allocations to meet the SLOs, for instance, in a period of a few minutes.

By way of example, a node controller 112 informs the pod controller 114 of the CPU requirements of various virtual machines and may also provide information pertaining to the available node capacity. In addition, the pod controller 114 receives resource consumption and capacity information of the nodes 132a-132n from the resource consumption and capacity sensors 126. If the pod controller 114 detects that the sum of the required allocations for all the VMs on a node add up to more than the node capacity, then the pod controller 114 determines that the workload (WL) migration actuators 128 need to be called upon to actuate migration of one or more of the workloads among one or more nodes 132a-132n in a pod 140a-140n.

According to another example, the pod controller 114 may tune the workload migration actuators 128 to migrate the workloads among the nodes 132a-132n to increase efficiency of the resource utilization in the nodes 132a-132n. For instance, the pod controller 114 may determine that placing workloads in one node 132a and setting another node 132b into an idle state may yield a more efficient use of the resources in the node 132a and may thus instruct the workload migration actuators 128 to place the workloads in the determined manner. According to an example, the idle node 132b can then be turned off to save energy.

The pod controller 114 is configured to perform intrapod migration among the nodes 132a-132n in a particular pod 140a and is configured to operate on a longer time scale as compared with the node controller 112, for instance, over periods of minutes. In addition, the pod controller 114 makes use of live migration, so that a user experiences very little, typically less than a second, of downtime during the migration process from one node to another. The actual migration, however, may take a relatively longer period of time, such as a few minutes. An example of a manner in which the pod controller 114 may operate is described in greater detail in copending and commonly assigned U.S. patent application Ser. No. 11/588,691 (Attorney Docket No. 200504718-1), the disclosure of which is hereby incorporated by reference in its entirety.

Additional types of suitable pod controllers 114 are described in C. Hyser, B. Mckee, R. Gardner, and B. J. Watson, “Autonomic virtual machine placement in the data center.” HP Labs Technical Report HPL-2007-189, February 2007 and S. Seltzsam, D. Gmach, S. Krompass and A. Kemper, “AutoGlobe: An automatic administration concept for service-oriented database applications.” Proc. Of the 22^{nd} Intl. Conf. on Data Engineering (ICDE '06), Industrial Track, 2006. The disclosures of those articles are hereby incorporated by reference in their entireties.

According to an example, the pod controller 114 is configured to pass pod performance data to the pod set controller 116 as indicated by the solid arrow 115, to facilitate integration between the node controllers 112, the pod controller 114 and the pod set controller 116. The pod performance data may include information pertaining to the arrangement of the workloads among the nodes 132a-132n. For instance, the pod performance data may include information pertaining to whether the resource requirements of the workloads as set forth in an SLO, for instance, have or have not been met. If the resource requirements have not been met, the pod controller 114 informs the pod set controller 116 that the resource requirements of the workloads have not been satisfied.

Generally speaking, the pod set controller 116 is configured to perform capacity planning for all of the pods 140a-140n contained in the pod set 150 and may be configured to run every few hours or more. The pod set controller 116 is thus aware of new workloads entering into the resource management system 100, old workloads that have been completed, historical data pertaining to how workloads have changed over time, etc. The pod set controller 116 may, for example, use the historical data to predict how workloads will change on certain days or certain hours. For instance, the pod set controller 116 is configured to determine whether a pod 140a-140n has become too overloaded and whether workloads should be redistributed between pods 140a-140n. Examples of manners in which the pod set controller 116 may operate are described in greater detail in copending and commonly assigned U.S. patent application Ser. No. 11/742,530 (Attorney Docket No. 200700357-1), U.S. patent application Ser. No. 11/492,376 (Attorney Docket No. 200601298-1), U.S. patent application Ser. No. 11/489,967 (Attorney Docket No. 200506225-1), filed on Jul. 20, 2006; U.S. patent application Ser. No. 11/492,347 (Attorney Docket No. 200504358-1), filed on Apr. 27, 2006; and U.S. patent application Ser. No. 11/493,349 (Attorney Docket No. 200504202-1), the disclosures of which are hereby incorporated by reference in their entireties.

The pod set controller 116 may communicate information pertaining to the predicted workloads back to the pod controller 114, as indicated by the solid arrow 115. The pod controller 114 may employ the information received from the pod set controller 116 and the service policy information when making workload migration determinations. As such, the pod controller 114 may make workload migration determinations among the nodes 132a-132n in a particular pod 140a using information that would have otherwise been unavailable to the pod controller 114.

By way of particular example, the pod set controller 116 may anticipate that some workloads are going to ramp up their resource demands at a certain time (for instance, an end-of-month report generation application) using historical analysis of the workloads as a predictor of the workload demands. In this example, the pod set controller 116 may inform the pod controller 114 of the impending increase in resource demand. In response, the pod controller 114 may place some of the current workload on its own machine, for instance, so that the pod controller 114 is better able to allocate the new workloads while substantially meeting the SLOs of the new workloads.

The pod set controller 116 may initiate a more global reorganization of the workloads than the pod controller 114 by moving one or more of the workloads between pods 140a-140n within a pod set 150 to better satisfy the resource requirements of the workloads, as indicated by the arrow 117. The pod set controller 116 may instruct a user 160 or a robotic device to physically rearrange the connections of a node 132a to form part of another pod 140b, to add a new node 132n to one of the pods 140a or to remove an existing node 132n from one of the pods 140a. In addition, or alternatively, the pod set controller 116 may instruct a node movement actuator (not shown) to change the association of the node 132a from one pod 140a to another pod 140b.

The pod controller 114 is distinguished from the pod set controller 116 because the pod set controller 116 is more focused on planning and also has a historical perspective of resource utilization for various workloads. In addition, although both the pod controller 114 and the pod set controller 116 have consolidation functions, they perform those functions in different degrees. For instance, the pod controller 114 performs these functions within a certain pod 140a, whereas the pod set controller 116 performs these functions among a plurality of pods 140a-140n. As a further distinction, because the pod controller 114 runs more often than the pod set controller 116, the pod controller 114 attempts to find the most efficient path, for instance, the solution that requires the smallest number of migrations, and thus the pod controller 114 attempts to minimize the overhead of migrating the virtual machines around. On the other hand, because the pod set controller 116 runs less often, for instance, every few hours or even less often, the pod set controller 116 attempts to perform more global optimizations and is less concerned with the cost of migration overhead.

The components of the resource management system 100 comprise software, firmware, hardware, or a combination thereof. Thus, for instance, one or more of the controllers 112, 114, 116 may comprise software modules stored on one or more computer readable media. Alternatively, one or more of the controllers 112, 114, 116 may comprise hardware modules, such as circuits, or other devices configured to perform the functions of the controllers 112, 114, 116 as described above. Likewise, the resource allocation actuators 122, the workload migration actuators 128, the application performance sensors 124, and the resource consumption and capacity sensors 126 may also comprise software or hardware modules.

The relationships between the nodes 132a-132n, the pods 140a-140n, and the pod set 150 may be stored as data, for instance, in a computer readable storage media. As such, the relationships may be stored as virtual relationships along with virtual representations of the nodes 132a-132n.

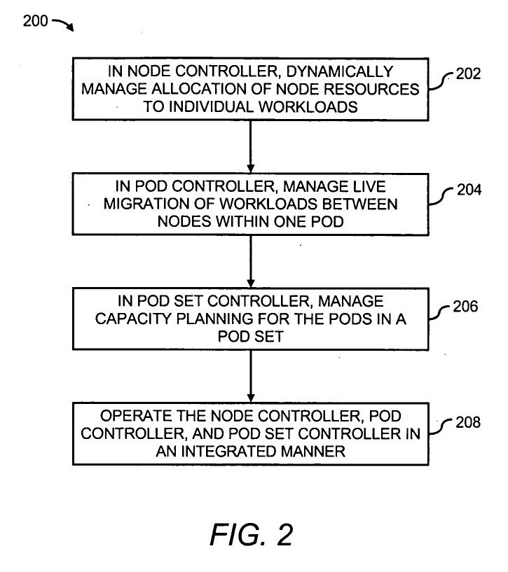

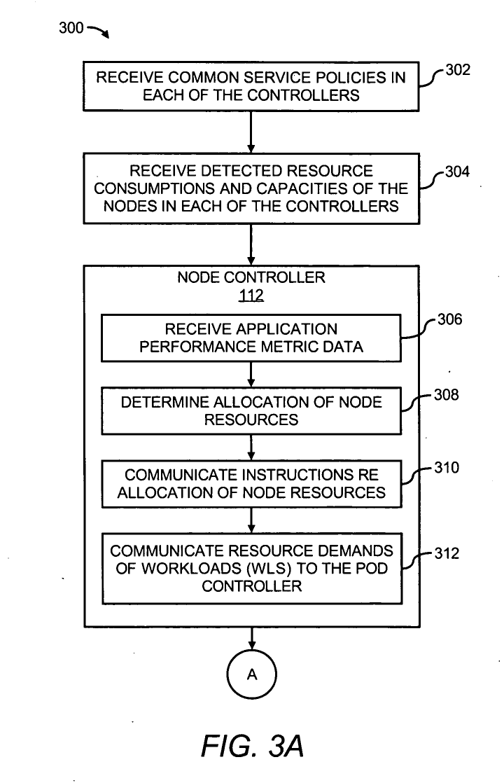

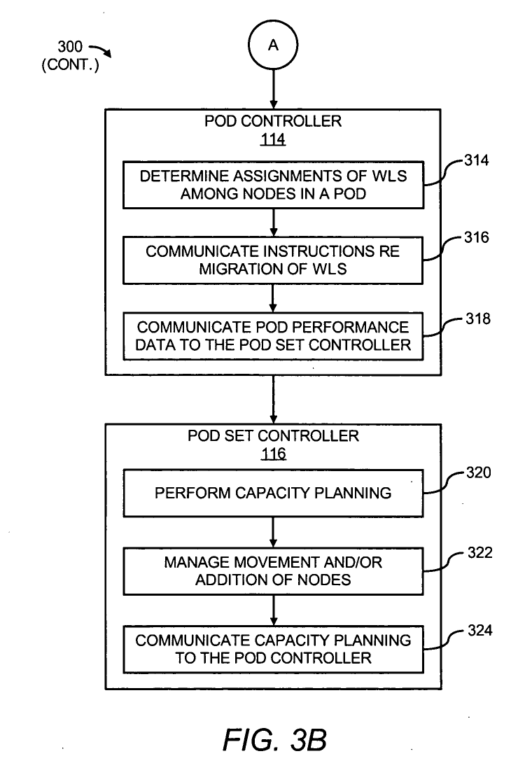

An example of a method of managing resources automatically among a plurality of nodes 132a-132n will now be described with respect to the following flow diagram of the method 200 depicted in FIG. 2, and the flow diagram of the method 300 depicted collectively in FIGS. 3A and 3B. It should be apparent to those of ordinary skill in the art that the methods 200 and 300 represent generalized illustrations and that other steps may be added or existing steps may be removed, modified or rearranged without departing from the scopes of the methods 200 and 300.

The descriptions of the methods 200 and 300 are made with reference to the resource management system 100 illustrated in FIG. 1, and thus make reference to the elements cited therein. It should, however, be understood that the methods 200 and 300 are not limited to the elements set forth in the resource management system 100. Instead, it should be understood that the methods 200 and 300 may be practiced by a system having a different configuration than that set forth in the resource management system 100.

The method 300 is similar to the method 200, but provides steps in addition to the steps contained in the method 200.

Turning first to FIG. 2, there is shown a flow diagram of a method 200 of managing resources automatically among a plurality of nodes 132a-132n, according to an example. At step 202, a node controller 112 manages the dynamic allocation of node resources to individual workloads. At step 204, a pod controller 114 manages live migration of workloads between nodes 132a-132n within one of the plurality of pods 140a. At step 206, a pod set controller 116 performs capacity planning for the pods 140a-140n contained in the pod set 150. As discussed above, each of a plurality of nodes 132a-132n is contained in one of a plurality of pods 140a-140n and the plurality of pods 140a-140n are contained in a pod set 150. In addition, at step 208, the node controller 112, the pod controller 114 and the pod set controller 116 are operated in an integrated manner to enable the node controller 112, the pod controller 114 and the pod set controller 116 to meet common service policies in an automated manner.

With reference now to FIGS. 3A and 3B, there is collectively shown a flow diagram of a method of managing resources among a plurality of nodes 132a-132n that is similar to the method 200 depicted in FIG. 2, but contains steps in addition to the steps discussed in the method 200, according to an example.

At step 302, the node controller 112, the pod controller 114, and the pod set controller 116 receive common service policies. As discussed above, each of the controllers 112, 114, 116 may receive a common set of service policies through the common user interface 102. In other words, service policy information that is inputted through the common user interface 102 may be communicated to each of the controllers 112, 114, 116. As such, the service policy information need not be inputted individually into each of the controllers 112-116 by a user.

At step 304, the controllers 112, 114, 116 receive resource consumptions and capacities of the nodes 132a-132n detected by the resource consumption and capacity sensors 126.

At step 306, the node controller 112 receives application performance metric data of the nodes 132a-132n from the application performance sensors 124. In addition, at step 308, the node controller 112 determines an allocation of node resources, for instance, for a particular workload, based upon the application performance metric data and service policy information from the common service policies received through the common user interface 102.

At step 310, the node controller 112 communicates instructions related to the allocation of the node resources determined at step 308 to the resource allocation actuators 122, which are configured to effectuate the allocation of the node resources in each of the nodes 132a-132n as determined by the node controller 112. In addition, at step 312, the node controller 112 communicates resource demands of the workloads to the pod controller 114, which, as described above, may differ from the actual resources allocated to the workloads.

Continuing on to FIG. 3B, at step 314, the pod controller 114 determines an assignment of the workloads among nodes in a particular pod 140a based upon the resource demands of the workloads received from the node controller 112, the resource consumptions and capacities of the nodes received from the resource consumption and capacity sensors 126, and the common service policies received at step 302.

At step 316, the pod controller 114 communicates instructions related to the assignment of the workloads among the nodes 132a-132n contained in a pod 140a to the workload migration actuators 128, which are configured to effectuate the determined allocation of the workloads among the nodes 132a-1 32n. At step 318, the pod controller 114 communicates pod performance data pertaining to the assignment of the workloads to the pod set controller 116.

At step 320, the pod set controller 116 performs capacity planning for the pods 140a-140n contained in the pod set 150 based upon the pod performance data received from the pod controller 114, the common service policies received at step 302, and the detected resource allocations and capacities of the nodes received at step 304. At step 322, the pod set controller 116 manages movement of nodes 132a-132n, which may include initiation of the removal of one or more of the nodes 132a-132n, among or from the pods 140a-140n contained in the pod set 150. In addition or alternatively, at step 322, the pod set controller 116 manages the addition of one or more nodes 132a-132n into one or more of the pods 140a-140n based upon the capacity planning performed at step 320.

At step 324, the pod set controller 116 communicates information pertaining to the capacity planning of the nodes to the pod controller 114. In addition, at step 314, in determining the assignment of the workloads among the nodes in a pod 140a, the pod controller 114 is further configured to base the determination of the workload assignment upon the capacity planning information received from the pod set controller 116

As may be seen from the methods 200 and 300, the node controller 112, the pod controller 114 and the pod set controller 116 are operated in an integrated manner to enable the controllers 112, 114, 116 to allocate resources and migrate workloads, such that the workloads may be completed while meeting service policies in an automated manner. The integration of the controllers 112, 114, 116 is enabled, for instance, through interfaces and communication of information across the interfaces between the controllers 112, 114, 116.

The operations set forth in the methods 200 and 300 may be contained as utilities, programs, or subprograms, in any desired computer accessible medium. In addition, the methods 200 and 300 may be embodied by computer programs, which may exist in a variety of forms both active and inactive. For example, they may exist as software program(s) comprised of program instructions in source code, object code, executable code or other formats. Any of the above may be embodied on a computer readable medium.

Exemplary computer readable storage devices include conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

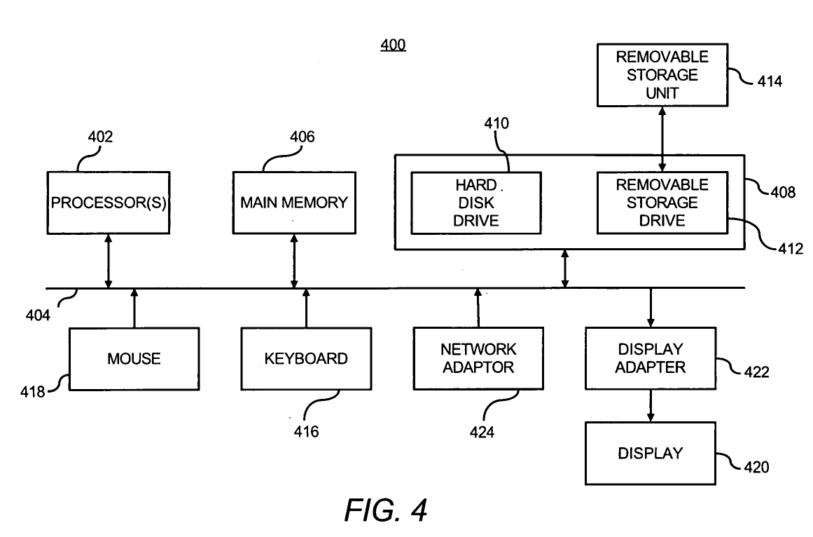

FIG. 4 illustrates a block diagram of a computing apparatus 400 configured to implement or execute either or both of the methods 200 and 300 depicted in FIGS. 2, 3A and 3B, according to an example. In this respect, the computing apparatus 400 may be used as a platform for executing one or more of the functions described hereinabove with respect to the resource management system 100 depicted in FIG. 1.

The computing apparatus 400 includes a processor 402 that may implement or execute some or all of the steps described in the methods 200 and 300. Commands and data from the processor 402 are communicated over a communication bus 404. The computing apparatus 400 also includes a main memory 406, such as a random access memory (RAM), where the program code for the processor 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for the methods 200 and 300 may be stored.

The removable storage drive 412 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A system for managing resources automatically among a plurality of nodes, said system comprising:
a node controller configured to dynamically manage allocation of node resources to individual workloads, wherein each of the plurality of nodes is contained in one of a plurality of pods;
a pod controller configured to manage live migration of workloads between nodes within one of the plurality of pods, wherein the plurality of pods are contained in a pod set;
a pod set controller configured to manage capacity planning for the pods contained in the pod set; and
wherein the node controller, the pod controller and the pod set controller are interfaced with each other to thereby enable the node controller, the pod controller and the pod set controller to operate to meet common service policies in an automated manner.

2. The system according to claim 1, further comprising:
a user interface, wherein the node controller, the pod controller and the pod set controller are commonly interfaced with the user interface, such that service policy information received through the user interface is communicated to each of the node controller, the pod controller and the pod set controller.

3. The system according to claim 2, further comprising:
a plurality of application performance sensors configured to measure application level performance metrics of the workloads performed on the nodes, wherein the plurality of application performance sensors are configured to communicate the measured application level performance metrics to the node controller, wherein the node controller is configured to determine an allocation of the node resources based upon the measured application level performance metrics and the service policy information; and
a plurality of resource allocation actuators configured to effectuate allocation of the node resources to the individual workloads based upon the determined allocations.

4. The system according to claim 2, wherein the node controller is further configured to determine resource demands of the workloads and wherein the interface between the node controller and the pod controller enables communication of the resource demands of the workloads from the node controller to the pod controller.

5. The system according to claim 4, further comprising:
a plurality of resource consumption and capacity sensors configured to detect resource consumptions and capacities of the nodes, wherein the plurality of resource consumption and capacity sensors are further configured to communicate the detected resource consumptions and capacities of the nodes to the node controller, the pod controller and the pod set controller.

6. The system according to claim 5, further comprising:
a plurality of workload migration actuators;
wherein the pod controller is further configured to determine an assignment of the workloads among one or more nodes contained in one of the plurality of pods based upon the detected resource consumptions and capacities of the nodes, the service policy information, and the resource demands of the workloads received from the node controller; and
wherein the plurality of workload migration actuators are configured to effectuate migration of the workloads among nodes contained in one of the plurality of pods based upon the assignment of the workloads determined by the pod controller.

7. The system according to claim 6, wherein the pod set controller is configured to receive pod performance data from the pod controller and to perform the capacity planning for all of the pods contained in the pod set based upon the pod performance data and the service policy information and to at least one of initiate movement of nodes between the plurality of pods and to initiate addition of nodes into the plurality of pods contained in the pod set based upon the capacity planning.

8. The system according to claim 1, wherein the nodes are assigned to one of the plurality of pods based upon an ability of the pod controller to live migrate workloads among the nodes in the one of the plurality of pods.

9. A method of managing resources automatically among a plurality of nodes, said method comprising:
in a node controller, dynamically managing allocation of node resources to individual workloads, wherein each of the plurality of nodes is contained in one of a plurality of pods;
in a pod controller, managing live migration of workloads between nodes within one of the plurality of pods, wherein the plurality of pods are contained in a pod set;
in a pod set controller, performing capacity planning for the pods contained in the pod set; and
operating the node controller, the pod controller and the pod set controller in an integrated manner to enable the node controller, the pod controller and the pod set controller to meet common service policies in an automated manner.

10. The method according to claim 9, further comprising:
in the node controller, receiving data pertaining to application level performance metrics of the workloads performed on a node, determining an allocation of the node resources based upon the measured application level performance metrics and the common service policies, and instructing a plurality of resource allocation actuators to effectuate allocation of the node resources based upon the determined allocations.

11. The method according to claim 10, further comprising:
in the node controller, determining resource demands of the workloads and communicating the resource demands of the workloads to the pod controller across the interface with the pod controller.

12. The method according to claim 11, further comprising:
in the node controller, the pod controller, and the pod set controller, receiving detected resource consumptions and capacities of the nodes; and
in the pod controller, determining an assignment of the workloads among one or more nodes contained in one of the plurality of pods based upon the detected resource consumptions and capacities of the nodes, the common service policies, and the resource demands of the workloads received from the node controller and instructing a plurality of workload migration actuators to effectuate the determined assignment of the workloads.

13. The method according to claim 12, further comprising:
in the pod controller, communicating pod performance data pertaining to the assignment of the workloads to the pod set controller; and
in the pod set controller, performing the capacity planning for all of the pods contained in the pod set based upon the pod performance data, the common service policies and the detected resource consumptions and capacities of the nodes and managing at least one of initiating movement of nodes between the plurality of pods and initiating addition of nodes into the plurality of pods contained in the pod set based upon the capacity planning.

14. The method according to claim 13, further comprising:
in the pod set controller, communicating information pertaining to the capacity planning of the nodes to the pod controller; and
wherein, in the pod controller, determining the assignment of the workloads among the nodes in a pod is further based upon the information received from the pod set controller pertaining to the capacity planning.

15. A computer readable storage medium on which is embedded one or more computer programs, said one or more computer programs implementing a method of managing resources automatically among a plurality of nodes, said one or more computer programs comprising a set of instructions for:
in a node controller, dynamically managing allocation of node resources to individual workloads, wherein each of the plurality of nodes is contained in one of a plurality of pods;
in a pod controller, managing live migration of workloads between nodes within one of the plurality of pods, wherein the plurality of pods are contained in a pod set;
in a pod set controller, managing at least one of initiating movement of nodes between the plurality of pods and initiating addition of nodes into the plurality of pods contained in the pod set; and
operating the node controller, the pod controller and the pod set controller in an integrated manner to enable the node controller, the pod controller and the pod set controller to meet common service policies in an automated manner.
